(19) United States
(12) Patent Application Publication
(10) Pub. No.: US 2008/0075819 A1
(43) Pub. Date: Mar. 27, 2008

(54) Treatment of mother's milk

(75) Inventors: Peter Hartmann, Gooseberry Hill (AU); Benjamin T. Hartmann, Cottesloe (AU); Charles Czank, Leeming (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Medela Holding AG, Baar (CH)

(21) Appl. No.: 11/903,360

(22) Filed: Sep. 21, 2007

Related U.S. Application Data
(60) Provisional application No. 60/846,544, filed on Sep. 22, 2006.

(51) Int. Cl. A23C 3/02; A23C 7/04

(52) U.S. Cl. 426/491; 426/522

(57) ABSTRACT

The invention provides a protocol for pasteurizing mother's milk that maximizes the retention of protein bioactivity while removing effective amounts of dangerous bacteria. This includes an optimal temperature at which the milk is held during pasteurization, as well as a very rapid rise to and then fall off from that holding temperature. The invention also provides a method for adjusting the fat content of mother's milk. This includes a method to standardize the energy content of mother's milk by adjusting the fat content by separating the milk contents, as by centrifuging, into at least fat and skim milk layers. The volume of skim milk is adjusted to meet the desired fat concentration, i.e., skim is removed to increase, or added to decrease.

### APPLICATION HISTORY

Applicant claims the benefit of prior pending U.S. Provisional Application Ser. No. 60/846,544 filed on Sep. 22, 2006, entitled “Milk Banking Mother's Own Milk.”

### FIELD OF THE INVENTION

This invention relates to the storage of mother's milk, and particularly the pasteurization of mother's milk, as well as the adjustment of the fat content of expressed mother's milk.

### BACKGROUND OF THE INVENTION

When mother's breastmilk is expressed, as by the use of a breastpump, it is most typically collected for later use. This ordinarily requires some kind of storage of the milk. That can include a simple step of freezing the milk, as in a home environment. In a hospital or other clinical-type environment, simple freezing may not suffice, or be desirable. Further, if the storage is going to be fairly long-term, or if the milk is being donated for others to use, as in a so-called milk bank, then a pasteurization step is often required. This serves to reduce the bacterial content of the milk, and promotes longer storage times.

It has been noted by the Applicant, however, that most pasteurizing processes used to the foregoing end in milk banks, tend to have a heating time and temperature that is likely to damage proteins and other constituents of the milk. This is, perhaps, a function of how cow's milk is treated, since maintaining protein bioactivity is not a concern with the latter.

A different storage issue is related to the fat content of the milk. In actuality, this has broader implications than just storage, as will be noted below. The “energy” content of human milk can be related to the fat content of the milk. If the fat content is too low in mother's milk donated to a milk bank, then it may be of little use for feeding. In a related vein, increasing the fat content of a particular mother's own milk can be of great value when dealing with a premature or underweight infant, or an infant that is having trouble feeding.

### SUMMARY OF THE INVENTION

One aspect of the present invention is an improved protocol for pasteurization of mother's milk that maximizes the retention of protein bioactivity while still removing effective amounts of deleterious bacteria. This protocol includes an optimal temperature at which the milk is held during pasteurization, as well as a very rapid rise to and then fall off from that holding temperature. The temperature of the milk rises more slowly as it approaches the pasteurization temperature. Preferably preheat temperature of >2° C. above the pasteurization temperature is contemplated, so that the milk reaches pasteurization temperature rapidly and then is held at the temperature.

Another aspect of the invention is an improved method for adjusting the fat content of mother's milk. More particularly, this can be a method to standardize the energy content of mother's milk by adjusting the fat content.

The improved method comprises separating the milk contents, as by centrifuging, into at least fat and skim milk layers. This is accomplished in a manner so that the fat layer is dense enough to have a majority of the milkfat in this layer, yet not so dense as to prevent simple resuspension thereafter, as by gentle shaking or stirring.

The volume of skim milk is then adjusted to meet the desired fat concentration, i.e., skim is removed to increase, or added to decrease.

These and other aspects, advantages, features and benefits of the invention will become apparent from the following specification.

### BRIEF DESCRIPTION OF THE DRAWINGS

FIG. 1 shows a prior art pasteurization curve (time vs. temperature);

FIG. 2 shows a pasteurization curve (time vs. temperature) according to an embodiment of the invention; and

FIG. 3 shows standardization of fat concentration of breast milk according to an embodiment of the invention.

### DETAILED DESCRIPTION OF EMBODIMENTS

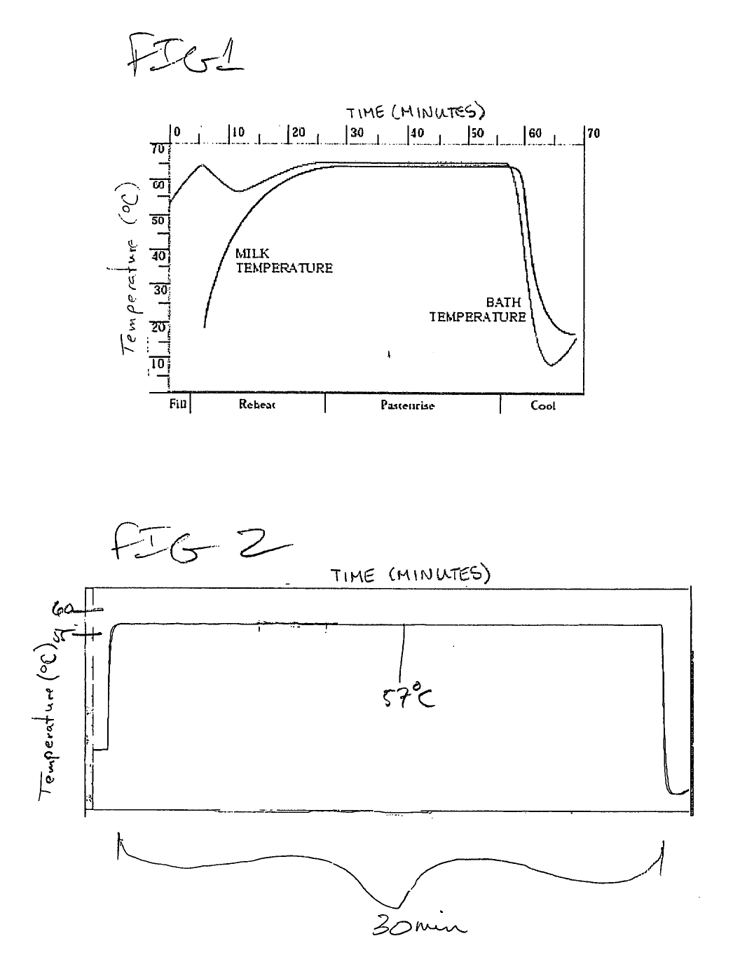

FIG. 1 shows a typical prior art technique for pasteurizing mother's milk (Sterifeed model). As will be noted, this technique uses a heating bath that relatively slowly brings the milk temperature up to a level over 60° C. (about 63° C.), where it is held for about 30 minutes. Then, a relatively slow cooldown occurs.

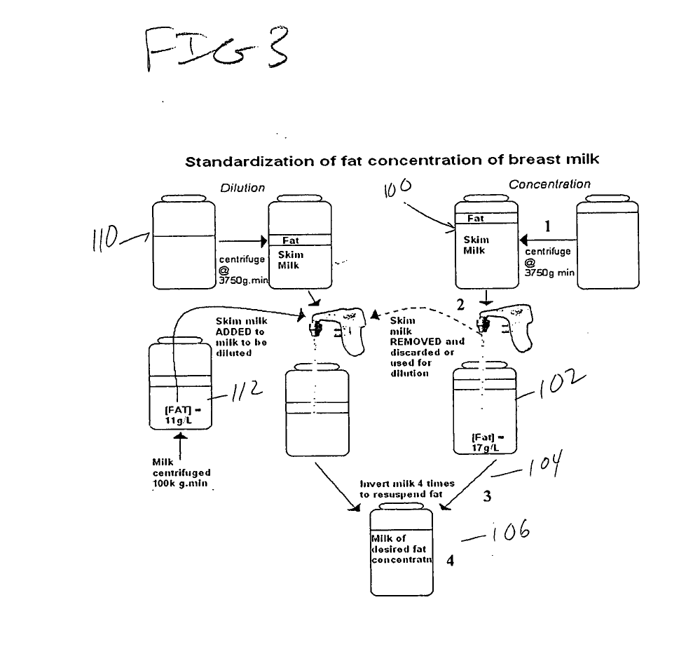

It is considered to be a major improvement, however, to bring the milk to a pasteurization temperature more rapidly, such as in about one (or even less than one) to five minutes, and to lower the temperature at which pasteurization is to be effected to at or below about 60° C., and most preferably about 57° C. This improved protocol is depicted in FIG. 2.

Applicant has determined that there is about a 60% retention of sIgA (Secretory immunoglobulin A) at an “accepted” milk banking temperature of 62.5° C. for 30 minutes. Yet at 57° C. for the same 30 minutes there is almost total retention. Further, deleterious bacteria will tend to be affected by rapid changes in temperature, more than individual proteins. Beneficial results have been determined from about 56° C. to less than about 60° C. The present invention therefore increases the temperature rapidly up to a most preferred optimal temperature of about 57° C., and holds that temperature for a sufficient time, here indicated at 30 minutes. The cool down period is preferably about five minutes.

In a related development, a method for adjusting the fat concentration of mother's milk is shown in FIG. 3. These are the steps as shown in this embodiment:
1) The milk is centrifuged at 3750 g.min at 4° C. to form a fat layer 100. The fat layer is dense enough so that the majority of the fat goes into the layer, but loose enough that it can be resuspended later. It is noted that the centrifugation conditions determine how dense the fat layer is, and therefore how easy it is to resuspend the fat layer back into the milk. Under these indicated conditions, all the fat will resuspend easily. If the milk is centrifuged under any significantly higher conditions, the fat layer will be too dense, and any significantly less, the layer is too weak to remove the skim milk through. Of course, there is some latitude in the foregoing, and the indicated parameters of temperature and force are not absolutes. If the process requires concentration the method begins at 100. If the process requires dilution, the process begins at 110. After being centrifuged, skim milk is added at 112. The process proceeds as described above at 104 and 106.
2) The volume of the skim milk below the fat layer is adjusted 102 to meet the desired fat concentration.
3) The fat layer is resuspended 104 by simply inverting the container, for example four times. This is optimal to prevent frothing and therefore protein denaturation.
4) Reconstituted milk 106 is of a desired fat concentration and therefore energy content.

The following algorithm was used to determine the volume of skim milk to remove at step 2:
Simple fat standardization algorithm:

$${V}_{2} = \frac{{V}_{1} {C}_{1} - {V}_{1} {C}_{3}}{{C}_{3} - {C}_{2}}$$
Where:
V₁=Initial volume of milk (ml)
V₂=Volume of skim milk to be removed or added (ml)
V₃=Final volume of milk after adjustment (ml)
C₁=Initial concentration of fat (g/L)
C₂=Concentration of fat in skim milk to be added or removed (g/L)
C₃=Desired fat concentration (g/L)

This equation is in its simplest form, and takes into account the fat content of the milk initially, the fat content of the skim after centrifugation and the desired fat content.

There is a more advanced algorithm that takes into account the initial concentrations of lactose and protein in addition to the above variables. This is based on the WHO recommendations for energy from fat=9 Kcal/g, protein=4 Kcal/g and carbohydrates=4 Kcal/g.
The advanced fat standardization algorithm taking into account fat, lactose and protein concentrations:

$${V}_{2} = \frac{{V}_{1} {C}_{1} - {V}_{1} {C}_{3}}{\frac{{E}_{D} - ( 4 {C}_{L} + 4 {C}_{P} )}{9} - {C}_{2}}$$
Where:
C_{L}=Initial concentration of lactose (g/L)
C_{P}=Initial concentration of protein (g/L)
C_{F}=C₃=Initial concentration of fat (g/L)
E_{F}=Energy derived from fat (Kcal/L)
E_{P}=Energy derived from protein (Kcal/L)
E_{L}=Energy derived from lactose (Kcal/L)
E_{T}=Total metabolisable energy=E_{D}=desired final energy content (Kcal/oz)

Thus, while the invention has been described herein with relation to certain embodiments and applications, those with skill in this art will recognize changes, modifications, alterations and the like which still come within the spirit of the inventive concept, and such are intended to be included within the scope of the invention as expressed in the following claims.

What is claimed is:

1. A method of treating human breastmilk, comprising:
heating a quantity of human breastmilk to a temperature of about 57° C. in less than about 5 minutes; and
maintaining the heated breastmilk within a temperature range having a minimum temperature of about 56° C. to a maximum temperature of less than about 60° C. for a period of about 30 minutes.

2. The method of claim 1, further including cooling the heated breastmilk to a desired temperature in less than about 5 minutes.

3. The method of claim 1, wherein the human breastmilk is heated to a temperature of about 57° C. in about one minute.

4. The method of claim 1, wherein the human breastmilk is heated to a temperature of about 57° C. in less than about one minute.

5. The method of claim 1, wherein the heated human breastmilk is maintained within a temperature range of about 56° C. to about 58° C. for a period of about 30 minutes.

6. An improved method for pasteurization of mother's milk that maximizes the retention of protein bioactivity while still removing effective amounts of dangerous bacteria, comprising the steps of:
rapidly raising the temperature of the milk to an optimal temperature, wherein said optimal temperature is in a range of between about 57° C. and about 60° C.;
holding the milk at or about said optimal temperature for a period sufficient to effect pasteurization; and then
allowing the milk to cool down after said holding period.

7. The method of claim 6, wherein said optimal temperature is about 57° C.

8. The method of claim 7, wherein said holding period is about thirty minutes.

9. An improved method for adjusting the milk fat content of mother's milk comprising the steps of:
separating the milk contents into at least milk fat and skim milk layers, with said separation operation being insufficient to prevent re-suspension of said milk fat and skim milk layers thereafter;
removing milk from said skim milk layer to thereby increase the milk fat concentration; and
re-suspending said milk fat layer with said skim milk layer.

10. The method of claim 9, wherein said separating step is accomplished through centrifugation.

11. The method of claim 10, wherein said re-suspension step is accomplished through manual shaking of said milk fat and skim milk in a container.
